(19) United States
(12) Patent Application Publication
(10) Pub. No.: US 2002/0084552 A1
(43) Pub. Date: Jul. 4, 2002

(54) Method for manufacturing a rubber product having colored patterns thereon

(76) Inventor: Kuo-Chun Yang, Taichung (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/749,537

(22) Filed: Dec. 28, 2000

(51) Int. Cl. B29C 43/18

(52) U.S. Cl. 264/247; 264/316

(57) ABSTRACT

A method for manufacturing rubber plate having colored patterns thereon includes step 1: to prepare a heat transfer decal having a colored pattern thereon; step 2: to prepare a male mold and a rubber plate put on the male mold, the decal put on the rubber plate; step 3: to prepare a female mold having a recess defined therein, and step 5: to press the decal on the rubber plate between the male mold and the female mold at a high temperature. The pattern on the decal is printed on the rubber plate.

### FIELD OF THE INVENTION

The present invention relates to a method for manufacturing a rubber label product by using a heat transfer decal to be pressed and heated on a rubber plate by molds to generate a rubber product with fine patterns.

### BACKGROUND OF THE INVENTION

Referring to FIGS. 1 and 2, a conventional rubber label used on coaster, trademark plate, sports shoes, key chain or zipper head is made by drawing a pattern 11 on a raw rubber plate 10, and then heating and pressing the rubber plate 10 by a male mold and a female mold. The male mold has a protrusion having exactly the same configure as the pattern, and the female mold has a recess having exactly the dame configure as the pattern. By the punch action of the male and female mold, a rubber plate 13 is punched and separated from the raw rubber plate 10 and has the pattern on the surface thereof. Nevertheless, it is difficult to paint colors on the raw rubber and the colors tend to fade out. After the rubber plate 13 is punched from the raw rubber plate 10, the periphery 14 of the punched rubber plate 13 looses the colors which are cut by the molds so that the manufacturers have to paint the periphery 14 manually.

The present invention intends to provide a method for manufacturing a rubber plate having colored pattern thereon.

### SUMMARY OF THE INVENTION

In accordance with one aspect of the present invention, there is provided a method for manufacturing rubber plate having colored patterns thereon. The method includes step 1: to prepare a heat transfer decal having a colored pattern thereon; step 2: to prepare a male mold and a rubber plate put on the male mold, the decal put on the rubber plate; step 3: to prepare a female mold having a recess defined therein, and step 5: to press the decal on the rubber plate between the male mold and the female mold at a high temperature.

The primary object of the present invention is to provide a method that clearly print colored patterns on a rubber plate.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a plan view to show a conventional raw rubber plate with a pattern thereon;

FIG. 2 is a perspective view to show a conventional rubber plate with the pattern thereon;

FIG. 3 is a flow chart to show a method of the present invention for manufacturing a rubber plate having colored patterns thereon;

FIG. 4 is an exploded view to show a female mold, a heat transfer decal, and a male mold in the method of the present invention;

FIG. 5 is a cross sectional view to show the decal in FIG. 4 is clamped between the male mold and the female mold;

FIG. 6 is a plan view to show the decal in the method of the present invention;

Fig, 7 is a perspective view to show the rubber plate having the pattern made by the method of the present invention, and

FIG. 8 is another embodiment of the rubber plate made by the method of the present invention.

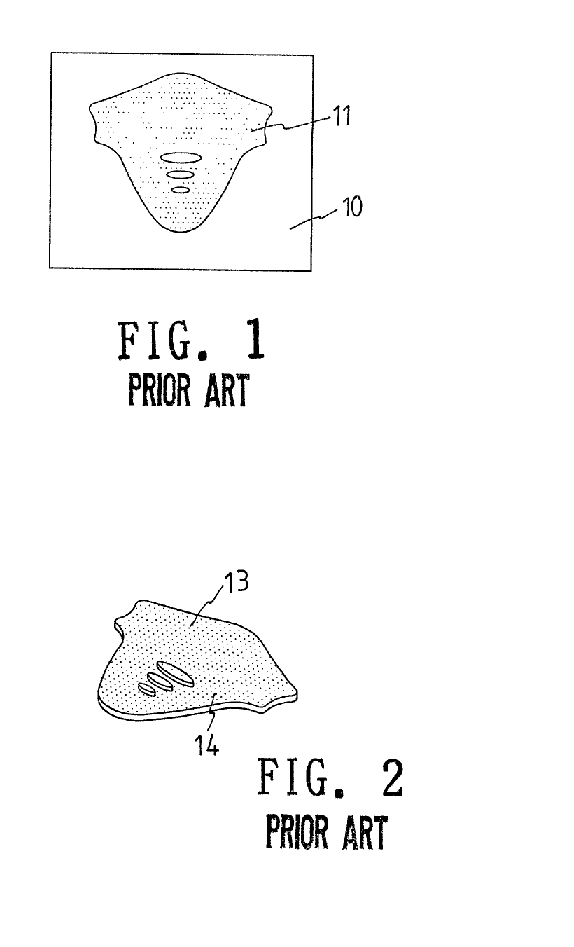

### DETAILED DESCRIPTION OF THE PREFERRED EMBODIMENT

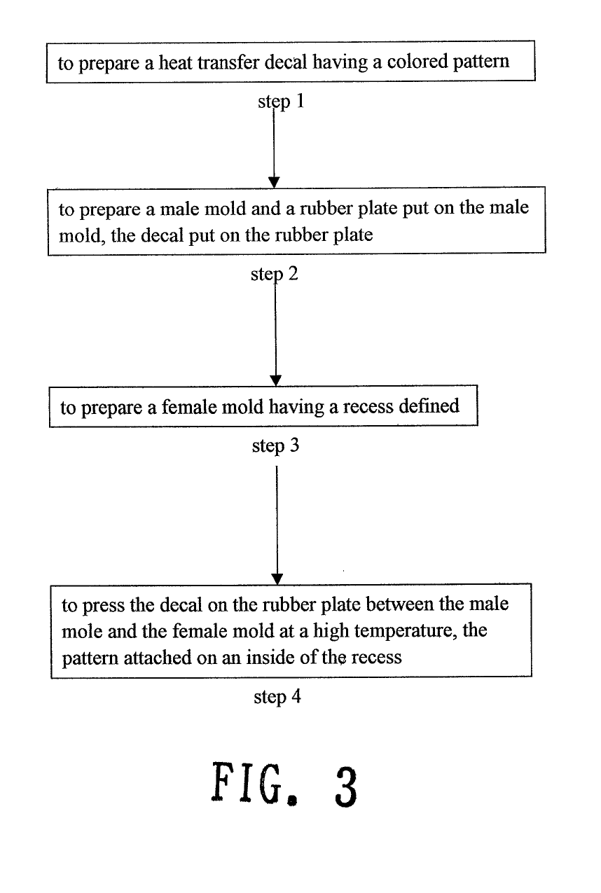

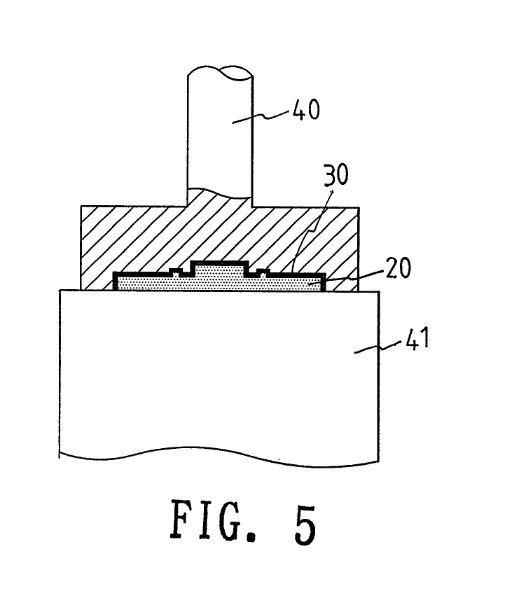

Referring to FIGS. 3 to 5, the method of the present invention for manufacturing a rubber plate having colored patterns thereon comprises the following steps:

step 1: To prepare a heat transfer decal 30 having a colored pattern 31 thereon. The pattern 31 includes six enclosed marks and each of the enclosed marks has a blank portion 33 and a colored frame 34 enclosing the blank portion 33.

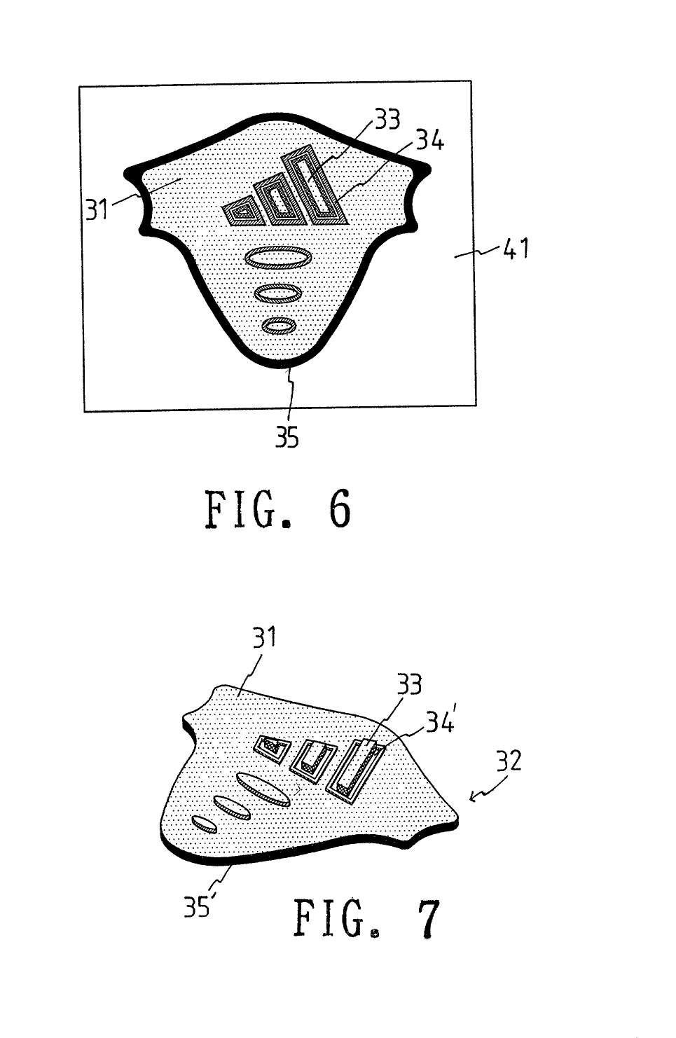

step 2: To prepare a male mold 41 and a rubber plate 20 put on the male mold 41 as shown in FIG. 6. The decal 30 is put on the rubber plate 20.

step 3: To prepare a female mold 40 having a recess 400 defined therein and six concavities 401 are defined in an inner surface of the recess 400 in the female mold 40. The configuration of the recess 400 is the same as the pattern 31. The width of the respective one of the colored frame 34 is equal to a depth of the respective one of the six concavities 401.

step 4: To press the decal 30 on the rubber plate 20 between the male mold 41 and the female mold 40 at a high temperature. The pattern 31 attached on an inside of the recess 400 and the enclosed marks are attached on an inside of the concavities 401. The frame 34 of each of the marks is printed on the depth surface of the respective one of the concavities 401.

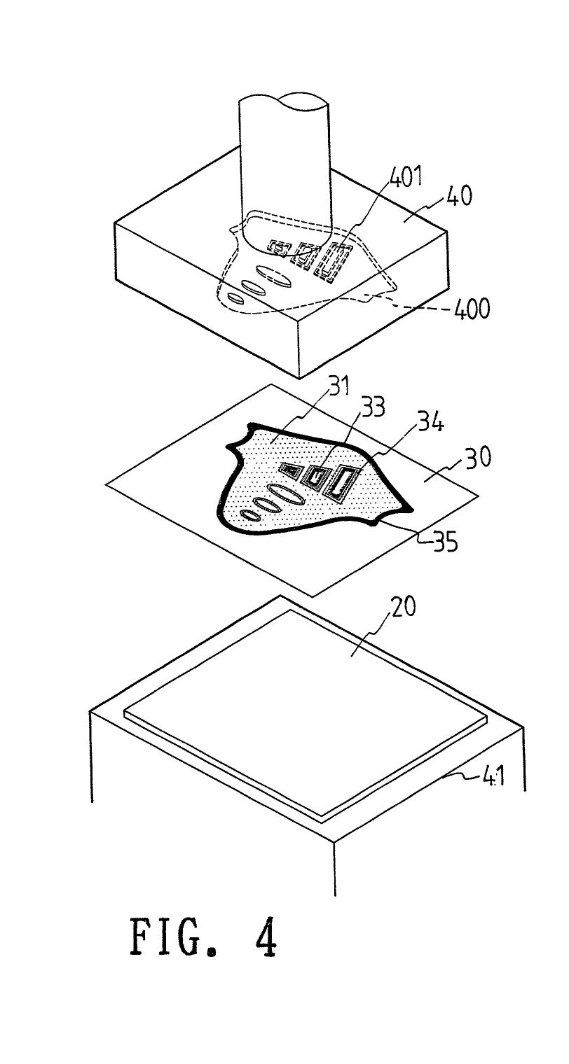

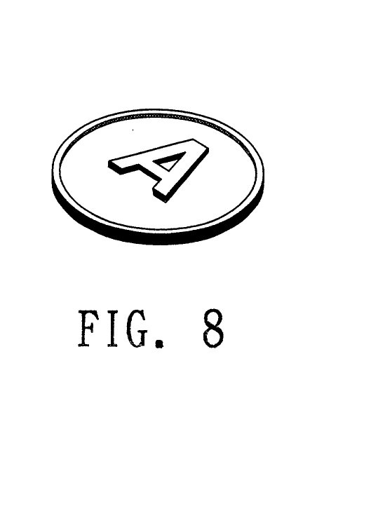

As shown in FIG. 7, there are six protrusions extending from the rubber plate 32 and the color on the frame 34 is printed on a peripheral wall 34′ of the respective one of the protrusions. The wide frame 35 enclosing the pattern 31 as shown in FIGS. 4 and 6 is printed on the thickness 35′ of the rubber plate 32. FIG. 8 shows another embodiment made by the method of the present invention.

While we have shown and described various embodiments in accordance with the present invention, it should be clear to those skilled in the art that further embodiments may be made without departing from the scope and spirit of the present invention.

What is claimed is:

1. A method for manufacturing rubber plate having colored patterns thereon, comprising the following steps:
step 1: to prepare a heat transfer decal having a colored pattern thereon;
step 2: to prepare a male mold and a rubber plate put on the male mold, the decal put on the rubber plate;
step 3: to prepare a female mold having a recess defined therein, and
step 4: to press the decal on the rubber plate between the male mold and the female mold at a high temperature, the pattern attached on an inside of the recess.

2. The method as claimed in claim 1 further comprising at least one concavity defined in an inner surface of the recess in the female mold.

3. The method as claimed in claim 1, wherein a configuration of the recess is the same as the pattern.

4. The method as claimed in claim 2 wherein the pattern includes a circular mark having a blank portion and a colored frame enclosing the blank portion, a width of the colored frame being equal to a depth of the at least one concavity.
